(19) United States
(12) Patent Application Publication
(10) Pub. No.: US 2007/0100663 A1
(43) Pub. Date: May 3, 2007

(54) Methods and systems for web based centralized patient assessment

(76) Inventor: Gary Zammit, Norwalk, CT (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/264,706

(22) Filed: Oct. 31, 2005

(51) Int. Cl. G06Q 10/00; G09B 3/00

(52) U.S. Cl. 705/2; 434/322

(57) ABSTRACT

Assessment of clinical trial data collected at different clinical trial sites is centralized to reduce statistical variance in clinical trial data. Secure network locations for collection of clinical trial assessment data are connected with a central clinical data management server and associated database. The clinical trial assessment data received from different clinical trial sites are assessed centrally using the clinical data management server. In some embodiments, a remote clinician is enabled to cooperate with clinical trial subjects in the collection of clinical trial assessment data.

### BACKGROUND

1. Technical Field

The present invention relates, in general, to handling and processing electronic clinical trials data at a centralized site, and more specifically, to the centralization of data assessment functions to reduce statistical variance in clinical trial datasets.

2. Related Art

Clinical trial programs are essential in the advancement of medicine and health care. They provide health care researchers and professionals with valuable information about the efficacy and safety of various treatments. They also provide patients and their physicians with access to new and alternative treatments. In order to gather more useful data a clinical trial may be carried out at various centers.

The use of centralized data processing services is common in multicenter clinical trials. In their simplest forms, such services are used for the processing of paper case report forms (CRFs). However, they also have been used in more complex circumstances, such as the handling of biological samples or physiological data. Centralized data processing generally allows data to be acquired in a standardized manner and processed at a single location using uniform and reliable methods. Clinical trials commonly employ centralized data services for the processing of electrocardiographic (EKG) tracings and radiographic or other image data collected in multicenter studies.

Centralized data processing methods have been used in the acquisition and analysis of electronic (digital) data. This trend has gained acceptance in the pharmaceutical industry. However, most electronic data handling methods simply provide a digital alternative to traditional paper handling methods, exploiting common advantages of the electronic environment (e.g., “cut & paste” and other electronic manipulation techniques). One problem in multicenter clinical trials is that multiple sites in different locations employ different clinicians and physicians as “raters” who assess patients at baseline (before receiving a drug) and at follow-up visits (after receiving a drug or placebo). Each site usually has one or two raters. Therefore, if a clinical trial employs 50 sites across the country, there may be between 50 and 100 raters.

One problem in multicenter clinical trials is that multiple sites in different locations employ different physicians or clinicians as “raters” who assess patients at baseline (before receiving a drug) and at follow-up visits (after receiving a drug or placebo). Each site usually has one or more raters. Therefore, if a clinical trial employs 50 sites across the country, there may be 50 or more raters involved in the assessment of subjects.

In order to standardize the methods that raters use to assess their patients, most studies require that raters be trained and that they demonstrate “inter-rater” reliability. However, the reliability and standardization between raters often is not consistent throughout the course of the trial. High levels of agreement reached on “training day” using one or two cases mayy drop to low levels once the raters are back in their individual offices.

The variance introduced by rater bias can be of great significance. For example, in depression studies it is known that statistically significant differences can be achieved with the difference of just a few rating points. On a 21-item scale, a score of 17 can indicate that a drug did not improve depression, but a score of 14 can indicate that it did improve depression. This numerical variance can make the difference between a failed trial and a successful one—and ultimately determines if a drug will be approved by the FDA. If we consider “depression” again, as an example, some of the serotonin specific reuptake inhibitors (SSRIs) were tested in multiple trials in order to document statistically significant effects on two studies as required by the FDA prior to approval.

### BRIEF SUMMARY

Clinical trials data is centrally assessed to reduce statistical variance in clinical trials datasets, especially in multicenter clinical trials. In accordance with one embodiment, standard operating procedures (SOPs) are prepared for use at clinical trials sites. This enables electronic data to be collected, handled, and transferred in a highly controlled manner. Standard operating procedures are also prepared for use at a central data processing facility. This enables electronic data to be handled, processed, analyzed, transferred, and archived in a highly controlled manner.

In accordance with another embodiment, statistical variance in clinical trials datasets are reduced by centralizing ratings over the internet. While patients seen at clinical trials sites across the country will be assessed by site staff locally, they also will be assessed via Web-based methods through the internet.

### BRIEF DESCRIPTION OF THE DRAWINGS

FIG. 1 illustrates a system providing electronic data acquisition and processing for centralized patient assessment in accordance with one embodiment.

FIG. 2 illustrates a system providing electronic data acquisition and processing for web based patient assessment in accordance with another embodiment.

FIG. 3 illustrates a web based patient assessment process in accordance with another embodiment.

### DETAILED DESCRIPTION OF THE PREFERRED EMBODIMENTS

Various exemplary embodiments are described with reference to the drawings. Elements of like structures or function are represented with like reference numerals throughout the drawings. The drawings are only intended to facilitate the description of specific embodiments of the invention and are not intended as an exhaustive description of the invention or as a limitation on the scope of the invention. In addition, an aspect described in conjunction with a particular embodiment is not necessarily limited to that embodiment and can be practiced in conjunction with any other embodiments of the invention.

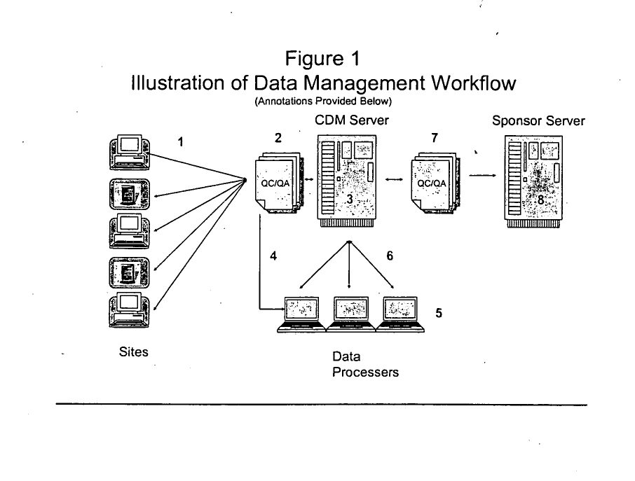

FIG. 1, entitled “Illustration of Data Management Workflow,” depicts a system providing electronic data acquisition and processing for centralized patient assessment in accordance with one embodiment of the present invention. The flow of electronic data acquisition and processing is depicted in FIG. 1. This method for processing electronic data enables the user to link multiple research sites 1 to a centralized data management (CDM) server 3. Quality control (QC) and quality assurance (QA) assessments 2, 7 are applied in an electronic environment by data processors 5 via communication link 4. Data processors 5 also manage the centralized data according to standard operating procedures provided by clinical sites and/or sponsors via communication link 6. Database systems are developed in accordance with sponsors' specifications and submitted to sponsors electronically to sponsor server 8.

In accordance with an embodiment, FIG. 1 provides centralized electronic data management at CDM server 3 and reduces variance in datasets via QC/QA assessments 2, 7 in accordance with the integrated standard operating procedures. The standard operating procedures required by sponsors determine how data processors 5 collect, handle, process, analyze, transfer, and archive datasets for each sponsor and/or clinical site.

In addition to reducing variance in datasets, this embodiment advantageously: reduces the likelihood of experimental confounds related to characteristics of the investigator or site; enables validity and reliability assessments of data to be performed in a routine manner; satisfies regulatory requirements regarding electronic data management; provides sponsors and regulatory authorities with required documentation at a single location, facilitating oversight by sponsors and regulatory agencies; allows electronic queries and quality control; allows electronic queries and quality control; allows the development of electronic databases; prepares data for electronic analyses; speeds the delivery of results; provides electronic (e.g., Web based) reports that can be prepared in “real time”; and allows data to be captured using a variety of instruments, including medical devices, computers, hand held devices, PDAs, telephones, or other instruments. Computer and PDA images in FIG. 1 are intended to represent any type of device.

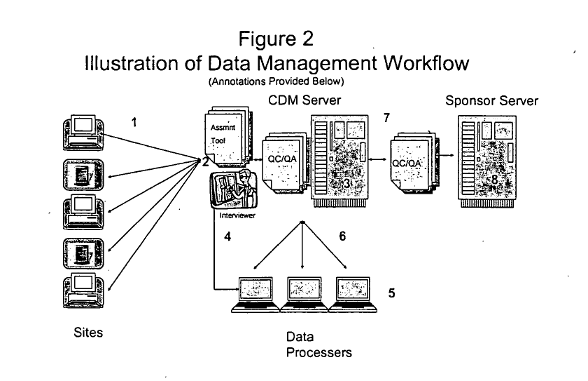

FIG. 2, entitled “Illustration of Data Management Workflow,” illustrates a system providing electronic data acquisition and processing for web based patient assessment in accordance with another embodiment. In one embodiment, ratings are centralized over the Web by allowing local and remote site staff to assess patients “live” and in “real time” as depicted in FIG. 2.

This method for processing electronic data enables the user to link multiple research sites I to a centralized data management (CDM) server 3. Quality control (QC) and quality assurance (QA) assessments 2, 7 are applied in an electronic environment by data processors 5 via communication link 4. Data processors 5 also manage the centralized data according to standard operating procedures provided by clinical sites and/or sponsors via communication link 6. Database systems are developed in accordance with sponsors' specifications and submitted to sponsors electronically to sponsor server 8.

In accordance with some embodiments, QA assessment 2 includes an assessment tool, including but not limited to a telephone, Voice over IP (VoIP), a handheld device, PDA, video conferencing, to connect a subject to a remote “live” rater by audio or video. FIG. 2 also provides the centralized electronic data management at CDM server 3 and reduces variance in datasets via QC/QA assessments 2, 7 in accordance with the integrated standard operating procedures. The standard operating procedures required by sponsors determine how data processors 5 collect, handle, process, analyze, transfer, and archive datasets for each sponsor and/or clinical site. Web-based applications can be used to provide standardized digital methods of subject assessment.

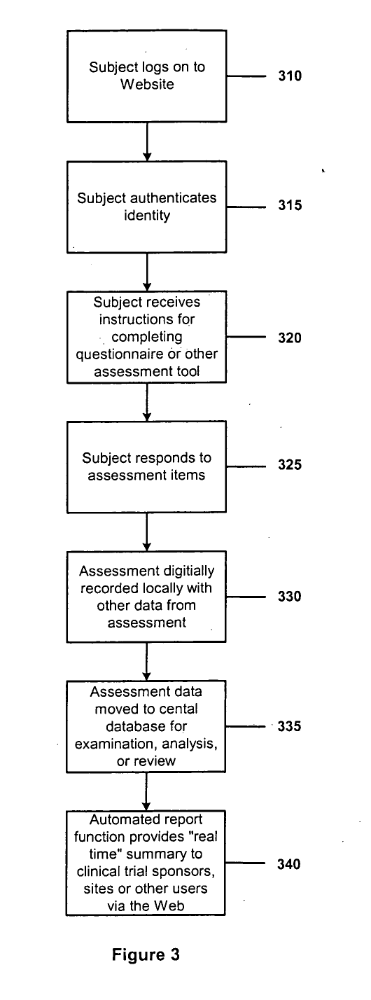

FIG. 3 illustrates an exemplary web-based patient assessment process. By way of example, process 300 enables electronic centralized assessment of a clinical trial subject during a clinical trial through the Internet. Process 300 is applicable in applications that include the collection, handling, processing, analyzing, transferring, and archiving of data from each assessment. However, this process is not intended as a limitation on the scope of the present invention. Process 300 can be performed through any type of network, e.g., Internet, Intranet, LAN, and so on, and can include other automated functions performed by the centralized data management server 3.

In step 310, the subject logs on to a Website using a unique identifier and password. In step 315, the subject provides authentication of identity using electronic signatures or other information (e.g., biometrics such as a finger print). In step 320, the subject receives instructions regarding the completion of questionnaire or other assessment tool, or connect with a remote “live” rater.

In step 325, the subject is presented with assessment items and responds. Preferably, the assessments include items that require specific responses (e.g., free-style response, multiple choice response, forced choice response, visual analog response, or other response). In accordance with some embodiments, the subject enters his/her response to assessment items using the computer keyboard or mouse. Alternatively, the subject may use a device other than a computer to access assessment tools (e.g., a handheld device, PDA, telephone, or other instrument).

In accordance with other embodiments, the assessments may be performed by a remote rater who interacts with the subject by audio (e.g., telephone or VOIP) and video connections. The rater may enter her responses confidentially or in a manner that informs the subject.

After the subject completes an assessment session, in step 330, the assessment sessions are digitally recorded (audio and video), along with other data regarding the assessment session (e.g., response times, reaction times, entries, corrections, revisions). QC/QA assessments automatically flag missing responses, and the subject may be asked to re-enter fields that contain missing data. In addition, unacceptable responses may be flagged, and the subject may be asked to re-enter data that appears to be inaccurate.

The assessment is date- and/or time-stamped, and in step 335, assessment data is moved to a centralized data management server for examination, statistical analysis, or review. Thereafter, the database may be queried via the data processors, automatically or initiated by sponsors, regulatory agencies, and clinical sites. Additional queries may be directed to the subject for follow-up.

In step 340, a report function provides real-time or summary reports to clinical trials sponsors, clinical trials sites, or subjects. Reports may be posted on a secure Web site that allows any number of users to privately access. The report function may be automated so that the data appear in “real time.”

The methods described here a dependent upon the use of Standard Operating Procedures (SOPs) at clinical trials sites and at a central data processing facility. The use of SOPs, combined with technology, enables the standardization of practices and procedures related to the acquisition, handling, processing, analysis, transfer, and retention of clinical trials data.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. A method for centralizing assessment functions in a clinical trial, comprising:
providing a network location for a clinical trial subject to visit for assessment;
authenticating the identity of the clinical trial subject;
providing at the network location an assessment tool for collection of assessment data;
receiving assessment data from the clinical trial subject;
transferring the assessment data to a central database; and
analyzing the assessment data.

2. The method according to claim 1, wherein authenticating the identity of the clinical trial subject comprises requiring the subject to provide identifying information.

3. The method according to claim 2 wherein the identifying information comprises an electronic signature.

4. The method according to claim 2 wherein the identifying information comprises biometric information.

5. The method according to claim 1, wherein said assessment tool is a questionnaire.

6. The method according to claim 1, wherein receiving assessment data from the clinical trial subject comprises receiving data obtained via the assessment tool.

7. The method according to claim 6 wherein the data obtained via the assessment tool is data responsive to a multiple choice query.

8. The method according to claim 6 wherein the data obtained via the assessment tool is data responsive to a forced choice query.

9. The method according to claim 6 wherein the data obtained via the assessment tool is data responsive to a visual analog query.

10. The method according to claim 1, wherein if the clinical trial subject fails to provide all necessary assessment data, the method further comprises:
providing notice of missing assessment data; and
prompting the clinical trial subject to submit the missing assessment data; and
receiving the missing assessment data.

11. The method according to claim 1, wherein if the clinical trial subject provides unacceptable assessment data, the method further comprises:
providing notice of unacceptable assessment data;
prompting the clinical trial subject to submit acceptable assessment data; and
receiving the acceptable assessment data.

12. The method according to claim 1, further comprising recording a date and time of receipt of the assessment data from the clinical trial subject.

13. The method according to claim 1, wherein the network location comprises a website.

14. A method of reducing variance of datasets in a clinical trial, the method comprising the steps of:
providing a network location for a clinical trial subject to visit for assessment;
authenticating the identity of the clinical trial subject;
providing a communications link between the clinical trial subject and a remote clinician;
providing at the network location an assessment tool for collection of assessment data from the clinical trial subject in cooperation with the remote clinician;
receiving assessment data from the clinical trial subject;
transferring the assessment data to a central database; and
analyzing the assessment data.

15. The method according to claim 14, wherein authenticating the identity of the clinical trial subject comprises requiring the subject to provide identifying information.

16. The method according to claim 15 wherein the identifying information comprises an electronic signature.

17. The method according to claim 15 wherein the identifying information comprises biometric information.

18. The method according to claim 14, wherein providing a communications link between the clinical trial subject and a remote clinician comprises providing an audio connection.

19. The method according to claim 18 wherein the audio connection comprises a telephone or voice-over-IP connection.

20. The method according to claim 14, wherein providing a communications link between the clinical trial subject and a remote clinician comprises providing a video conference connection.

21. The method according to claim 14, wherein said assessment tool is a questionnaire.

22. The method according to claim 14, wherein receiving assessment data from the clinical trial subject comprises receiving data obtained via the assessment tool.

23. The method according to claim 14 wherein the data obtained via the assessment tool is data responsive to a multiple choice query.

24. The method according to claim 14 wherein the data obtained via the assessment tool is data responsive to a forced choice query.

25. The method according to claim 14 wherein the data obtained via the assessment tool is data responsive to a visual analog query.

26. The method according to claim 14 wherein the remote clinician inputs the assessment data.

27. The method according to claim 14, wherein if the clinical trial subject fails to provide all necessary assessment data, the method further comprises:
providing notice of missing assessment data; and
prompting the clinical trial subject to submit the missing assessment data; and
receiving the missing assessment data.

28. The method according to claim 14, wherein if the clinical trial subject provides unacceptable assessment data, the method further comprises:
providing notice of unacceptable assessment data;
prompting the clinical trial subject to submit acceptable assessment data; and
receiving the acceptable assessment data.

29. The method according to claim 14, further comprising recording a date and time of receipt of the assessment data from the clinical trial subject.

30. The method according to claim 14 wherein the network location comprises a website.

31. A system for centralized assessment of clinical trial data, comprising:
at least one clinical data management server comprising at least one clinical trial assessment database and analysis software operative to analyze clinical trial assessment data stored in the at least one clinical trial assessment database;
at least one assessment site located at a secure network location and including at least one assessment tool for collection of clinical trial assessment data; and
a communications link-providing communication between the at least one clinical data management server and the at least one assessment site.

32. The system of claim 31 wherein the at least one assessment tool comprises a questionnaire.

33. The system of claim 32 wherein the questionnaire comprises a multiple choice query.

34. The system of claim 32 wherein the questionnaire comprises a forced choice query.

35. The system of claim 32 wherein the questionnaire comprises a visual analog query.

36. The system of claim 31 wherein the secure network location comprises a website.

37. The system of claim 31, further comprising a remote clinician site connected with the at least one assessment site via a remote clinician communications link, the remote clinician site operative to enable a remote clinician to interface with the at least one assessment tool.

38. The system of claim 37 wherein the remote clinician communications link comprises at least one of audio communications and video communications.

39. The system of claim 38 wherein the remote clinician communications link comprises a video conference link.
